(19) United States
(12) Patent Application Publication
(10) Pub. No.: US 2019/0213621 A1
(43) Pub. Date: Jul. 11, 2019

(54) DEAL QUALITY FOR EVENT TICKETS

(71) Applicant: SEATGEEK, INC., New York, NY (US)

(72) Inventors: Jon D GROETZINGER, New York, NY (US); Eric R.J. WALLER, New York, NY (US); Russell P D'SOUZA, New York, NY (US); Adam D COHEN, New York, NY (US); Steve Andrew RITTER, New York, NY (US)

(21) Appl. No.: 16/356,703

(22) Filed: Mar. 18, 2019

Related U.S. Application Data
(63) Continuation of application No. 13/339,423, filed on Dec. 29, 2011.
(60) Provisional application No. 61/428,622, filed on Dec. 30, 2010.

(51) Int. Cl. G06Q 30/02

(52) U.S. Cl. CPC G06Q 30/0207; G06Q 30/0283

(57) ABSTRACT

A deal value metric (or “deal score”) enables consumers to identify the quality of a ticket listing, and facilitates direct comparison of available event tickets having varying quality throughout a venue. The deal value metric disclosed herein also permits simultaneous comparison of tickets among multiple similar events, and provides a helpful criterion to supplement conventional search filters such as location or price.

### RELATED APPLICATIONS

This application is a Continuation of U.S. application Ser. No. 13/339,423, filed Dec. 29, 2011, which claims priority to Provisional Patent Application No. 61/428,622, filed on Dec. 30, 2010, the entire content of which is hereby incorporated by reference.

### BACKGROUND

The market for tickets to events such as sports, concert, theater, and the like has flourished online, producing numerous secondary markets and. Internet vendors of such tickets. There are websites that aggregate available inventory to facilitate end user searching. However, when a large amount of inventory is aggregated, it can be difficult for consumers to isolate the best available deals. Unlike inventory aggregation in other markets (e.g. airline travel), consumers cannot identify the best deals b simply looking at the cheapest tickets. In the context of event tickets, the cheapest tickets are usually those located in the least desirable area of a venue, and the fair price for a particular seat may depend more generally on a wide range of factors such as orientation and distance to a point of interest.

There remains a need for a deal value metric that permits consumers to directly compare the quality of ticket offerings throughout a venue.

### SUMMARY

A deal value metric (or “deal score”) enables consumers to identify the, quality of a ticket listing, and facilitates direct comparison of available event tickets having varying quality throughout a venue. The deal value metric, disclosed herein also permits simultaneous comparison of tickets among multiple similar events, and provides a helpful criterion to supplement conventional search filters such as location or price.

### BRIEF DESCRIPTION OF THE FIGURES

The invention and the following detailed description of certain embodiments thereof may be understood by reference to the following figures:

FIG. 1 shows a ticket transaction environment.

FIG. 2 is a flow chart of a process for calculating a deal value metric.

FIG. 3 shows an interactive graphical user interface displaying a deal value metric.

FIG. 4 shows a user interface with interactive access to ticket information.

### DETAILED DESCRIPTION

In the following description, a ticket listing of high “quality” is one that an ordinary consumer would consider to be a good value based on its price, location within a stadium, number of tickets within the listing, method by which the tickets will be delivered, and other variables that drive consumer-perceived worth. The systems and methods herein address techniques for calculating a deal score—a figure of merit that quantitatively captures this seat quality in a manner that permits comparison across available seats in a venue independent of price, location, and any other factors that may subjectively or objectively affect quality.

The specific nature of deal score can take several different forms. In some embodiments, deal score may be a number between 0 and 100, where 0 represents the lowest-quality currently available deal for an event and 100 represents the highest-quality currently available deal. In other embodiments, deal score may be an unbounded number that has an average of 0 and has no explicit maximum or minimum. In other embodiments, deal score may be calculated for tickets across a number of similar events such as single round of playoff games or a number of performances by a musician or band (which may for example be successive performances in a single venue or geographically proximate performances). It will be appreciated that the term “deal score” refers by way of example and not limitation to a commercial embodiment of the deal value metric disclosed herein. Thus numerous variations to the numerical bounds and methods for calculating the deal score are possible without departing from the scope of this disclosure.

The variables that are used to compute a deal score are not fixed and can vary based on the event type and the intended application of the metric. However, the retail and secondary market prices of a ticket listing will typically be a factor contributing to a deal score. In some embodiments, the location of the tickets within a venue also contributes to a deal score. Several methods can be used to calculate the effect of a ticket's location. In some embodiments, an algorithm may use the historical average transaction or list price of a ticket's row and/or section relative to other rows and/or sections within the venue. The algorithm may also or instead use the distance to points of interest (e.g. the 50 yard line, home plate, performance stage, etc.) or the fan's viewing angle to such points of interest. Similarly, amenities available to a particular seat may contribute favorably to deal score.

In certain ticket sale environments, a ticket does not have any explicit sale price, and the initial price may simply be the first offered price in an auction or the like. In such cases, the “list” price may instead be an initial offered price, or an initial retail sale price at which the ticket was sold through the auction, lottery, or other market. The initial acquirer may subsequently resell the ticket on a secondary market, in which case the ticket holder may or may not divulge the actual price at which the ticket was acquired. In such instances, the price may be inferred based on similar ticket sales, or the algorithm may omit the face value or “list price” in deal score calculations. More generally, a variety of modifications to the algorithms described herein may be made to accommodate unusual or varying primary market techniques.

In addition to seat location, some embodiments of the deal score algorithm will also consider the number of tickets in the listing. A group of tickets offered for sale may include anywhere between one and over twenty-five tickets. The quantity of tickets (and their adjacency) in a listing can affect attractiveness to consumers. For example, a listing with a single ticket generally has a lower per-ticket price than a listing with two tickets.

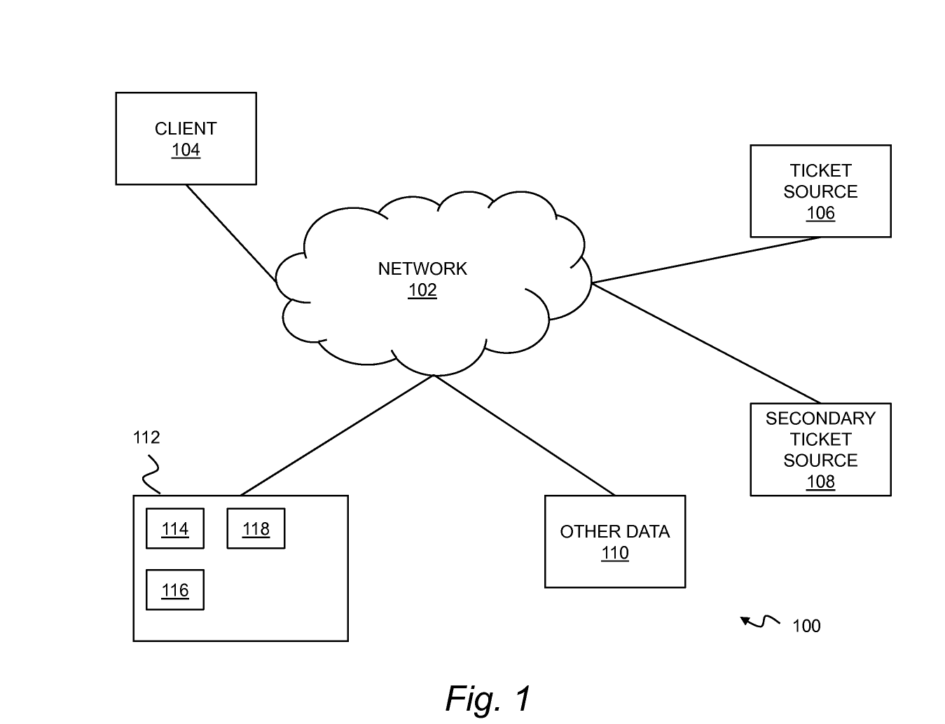

FIG. 1 shows a ticket selling environment. In general, the environment 100 may include a data network 102 interconnecting a plurality of participating devices in a communicating relationship. The participating devices may, for example, include a client 104, a ticket source 106, a secondary ticket source 108, other data sources 110, a transaction server 112, and a ticket server 112. It will be understood that while one of each of the foregoing devices is illustrated, any number of such devices may participate in the environment 100. While there is a large volume of secondary market ticket transactions, and the following description focuses on evaluating ticket resale offers, it will be understood that a deal score or the like may also be calculated for an initial sale (i.e., primary market offering), or more generally any sale for which historical data can be acquired to evaluate pricing, without departing from the scope of this disclosure, and all such variations that would be apparent to one or ordinary skill in the art are intended to fall within the scope of this disclosure.

The data network 102 may be any network(s) or internetwork(s) suitable for communicating data and control information among participants in the environment 100. This may include public networks such as the Internet, private networks, telecommunications networks such as the Public Switched Telephone Network or cellular networks using third generation (e.g., 3G or IMT-2000), fourth generation (e.g., LTE (E-UTRA) or WiMax-Advanced (IEEE 802.16m) technology, as well as any of a variety of corporate area or local area networks and other switches, routers, hubs, gateways, and the like that might be used to carry data among participants in the environment 100.

The client 104, of which there may be any number participating in the environment 100, may be operated ley a user to initiate a search for tickets using the ticket server 112. The client 104 may include a desktop computer, a laptop computer, a network computer, a tablet, or any other computing device or combination of devices that can participate in the environment 100 as contemplated herein. Each client 104 generally provides a user interface, which may include a graphical user interface and/or text or command line interface to control interactions with the ticket server 112 in order to search and select tickets according to a deal score as generally contemplated herein. The user interface may be maintained by a locally executing application on one of the clients 104 that receives data concerning tickets from the ticket server 112, or the user interface may be remotely served and presented on the client 104, or some combination of these.

The client 104 may be a mobile device, such as any wireless, battery-powered device, that might be used to interact with the ticket server 112. The mobile device may, for example, include a laptop computer, a tablet, a thin client network computer, a portable digital assistant, a messaging device, a cellular phone, a smart phone, a portable media or entertainment device, and so forth. In general, mobile device may be operated by a user for a variety of uses rented functions such as to locate tickets according to a deal score and to purchase tickets from the secondary ticket source 108.

The ticket source 106 may be an online ticket source operated by a primary ticket vendor such as a venue operator, a sports team, or any other source of tickets sold directly into a retail market.

The secondary ticket source 108 may be any ticket reseller that aggregates event tickets from a plurality of sources and lists the event tickets for sale at an offering price.

The other data sources 110 may include, any other sources of ticket pricing information that might be usefully employed by the ticket server 112 to predict ticket prices and evaluate deal scores for offered tickets. In one aspect, this includes third party vendors of ticket price data, which may be obtained from any other source or combination of sources. In another aspect, this may include sources of league standings, playoff prospects, game results, weather, and any other information that might be correlated to a price of an event ticket to more accurately predict a sale price.

The transaction server 112 may include any resource for processing financial transactions including without limitation a bank transaction server, online payment server (such as PayPal), a credit card transaction server, and so forth. In general, two modes of operation are contemplated. In a first mode, a user may complete a purchase of tickets using the ticket server 112, which may access any suitable transaction server 112 to process a payment for tickets. In a second mode, the ticket server 112 may simply serve as a search engine, and may refer a user (by hyperlink, new page, or any other suitable mechanism) to the aggregator or other ticket reseller that is offering the ticket once the user has identified one or more tickets for purchase. It should also be understood that any suitable arrangement or combination of arrangements for transacting in event tickets may also or instead by used with the ticket server 112 and deal scores as described herein.

The ticket server 112 may be a server configured to aggregate pricing data from the other environment participants, predict ticket prices for tickets currently offered in a secondary market, and to evaluate an offering price for such tickets, all using techniques described in greater detail below. The ticket server 112 may include a connection to the data network (along with a network interface card or other suitable interface hardware) and a number of software modules configured to perform related tasks. This may, for example include a web scraper 114 to search for data relevant to current prices and price prediction, a scoring engine 116 that processes data gathered by the web scraper 114 in order to calculate deal scores for tickets offered for sale, and a web server 118 configured to receive information requests from the client 104 and provide responsive deal score information in a user interface such as a web page. While these modules are depicted as discrete modules within the ticket server 112, it will be understood that the ticket server 112 and/or various functional modules thereof, may be deployed in a cloud computing environment or the like so that logical instances of the ticket server 112 and software modules are distributed across any one or more physical devices. Or the ticket server 112 and modules thereof may reside on a single hardware platform that may optionally be co-located with any of the other entities described above such as ticket sources 106 or secondary ticket sources 108. Thus the foregoing description should be understood to provide a general characterization of the participants in an environment 100 for ticket sales, and is not intended to limit the environment 100 to any particular computer, software or network architecture, except where explicitly stated below or otherwise clear from the context.

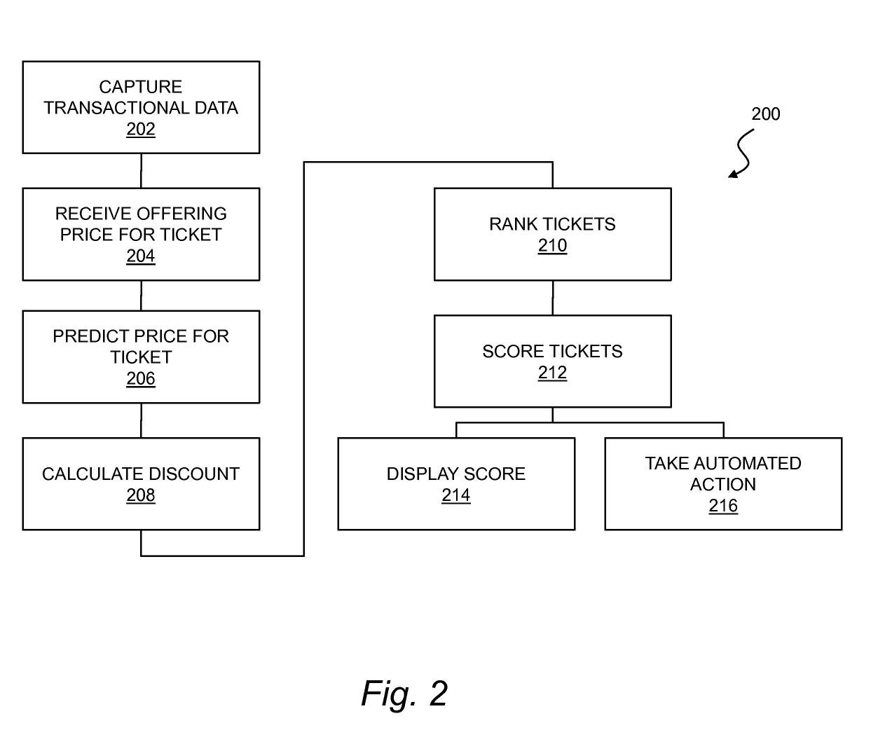

FIG. 2 is a flowchart of a process for calculating a deal value metric. In general, the process 200 contemplates use of a web-based application served by the ticket server described above, through which remote users operating client devices may search for and initiate purchase of tickets; however, many variations are possible including variations using a mix of local and remote data and/or local and remote processing. Notwithstanding the specific example embodiment provided below, the process 200 generally includes aggregating ticket data, evaluating the ticket data to determine a deal value metric for individual tickets, and ranking the tickets according to a comparison of the offering price to the deal value metric. The techniques described below advantageously permit side-by-side comparison of various ticket offerings independent of ticket location and price so that good deals can be more readily identified by a consumer.

As shown in step 202, the process 200 may begin with capturing transactional data for ticket sales to one or more events of an event type at a venue. The transactional data for ticket sales may include primary market data, secondary market data, or some combination of these. The venue may be any venue where tickets for an event are sold including indoor or outdoor venues, sports stadiums, performance halls, and so forth. The event type may be specified at various levels of abstraction. Thus the event type may specify a music concert or a sports event, or the event type may specify a football game, a baseball game, a basketball game, a hockey game, a soccer game, and so forth. The event type may further distinguish between, e.g., professional, collegiate, and other types of sports events. In another aspect, the event type may specify a particular type of game within a sports type and season, such as a regular season game, a game against a divisional rival, a playoff game, a championship game, and so forth. Other data such as the date and time of the event may also be captured in order to perform time-based calculations relating to actual or predicted price.

A variety of techniques may be employed to capture transactional data. This may include inferences drawn from publicly available information and/or data purchased or otherwise acquired for commercial sources. Sales of tickets may be inferred, for example, when a ticket is listed for sale and then subsequently becomes unavailable. In another aspect, ticket transactional data may be purchased from a third party vendor of market data, or directly from ticket agents and other resellers where this data is made available for purchase. In another aspect, ticket purchases initiated through the ticket server may be tracked and included in a database of transactional data. Thus the transactional data may include ticket sales such as actual or inferred ticket sales. The transactional data may also or instead include ticket offers for sale where, for example, an event has not yet occurred and tickets remain available on a secondary market. More generally, any source or group of sources, whether publicly available or commercially available for purchase, may provide transactional data relating to offering prices and sales of ticket. The ticket server may aggregate this ticket data into a single comprehensive feed or other database or data structure. The results may be stored in any suitable computer-readable memory as a canonical or comprehensive list of available inventory.

In one aspect, capturing transactional data may include deduplicating ticket offers for sale so that each offered ticket is only counted one time in price calculations. Where multiple instances of a ticket exist for sale through multiple vendors, a lowest price (which may include reseller fees, shipping costs, etc.) may be selected for the ticket.

Other pre-processing of the transactional data may also usefully be performed. For example, price data within the transactional data may be normalized according to the position of a row of a ticket relative to a point of interest within a venue, or within a section of the venue. Normalizing price data may also or instead include normalizing the price data according to an average price for an event, an average price for each of a number of events of an event type, or a get-in price for the event representing a minimum amount supported by the market to attend the event. The transactional data may also or instead be normalized by training a linear model independently for each of a first row, a second row, and a third row of one or more sections for at least one of the one or more events so that historical data for those ticket locations can be combined with other historical data without inappropriately skewing price data toward premium seating data points. Normalizing the transactional data may also or instead include normalizing the transactional data to account for market trends as an event date approaches. For example, a specific ticket at a specific seat location may have a substantially different price one month from an event, one week from an event, and one hour from an event. This generally does not imply a price change relative to other ticket locations, but rather a price change based upon the time until the event occurs. Thus transactional data may be normalized according to a date of transaction, or according to a date of transaction relative to a date of event in order to account for time-based market trends as an event approaches. Any time-based normalization may similarly be employed, which may vary according to venue, event type, or other criteria, and which may in general be modeled based on observations of historical sales data.

As shown in step 204, the process 200 may include receiving an offering price for a ticket offered for sale to a current event of the event type. In general, the transactional data may include sales data for a current event, e.g., the event for which a client is currently searching for tickets. Thus it will be understood that the step of receiving an offering price for a ticket, as contemplated herein, may be a sub-step of the data harvesting performed in step 202, particularly where data for current offers and historical sales transactions are obtained from the same sources. In general, ticket data from these sources may be sorted into tickets for which a sales transaction has occurred and tickets that are currently for sale, the latter being tickets that are scored for user evaluation as described further below. It should also be understood that this step 204 is not intended to imply that only a single offered ticket is received. Instead it is generally contemplated that numerous tickets will be available for sale at a given time and that this step 204 may be repeated many times or performed in bulk with any frequency appropriate to a secondary market for the current event. It should further be appreciated that the offering price for unsold tickets may also be relevant to price prediction and scoring, and as such this data may also optionally be used as transactional data in the steps described below.

As shown in step 206, the process 200 may include predicting a price for the ticket using a representative price for the current event, which may be adjusted according to a section within the venue for the ticket, and according to a row within the section, thereby providing a predicted price. The representative price may for example, be an average price for the current event (for which tickets are being sought), an average price for the type of the current event, a median price for the current event, or any other suitable representative price. In one aspect, the representative price may be a get-in price representing a minimum amount supported by the market to attend the current event. The get-in price may be calculated based on an estimated secondary market price for a cheapest ticket in a venue, or using some other metric. In certain circumstances, such as for non-sold out events, the get-in price may theoretically be below a face value for a ticket, or even negative. Although a negative get-in price suggests certain pricing anomalies for predicted prices on low-priced tickets, it may nonetheless serve as a useful representative value for evaluating offering prices for tickets in a secondary market. In one aspect, predicting a price for a ticket may include weighting a predicted price obtained using, e.g., the statistical models discussed below, using a multiple of the get-in price for an event.

By way of non-limiting example, a model for price prediction may be developed by assuming a log-normal distribution of ticket prices for two distinct distributions—tickets across all sections of a venue for an event, and tickets for a section across all events. Missing values may be imputed with a mean and variance equal to the observed distributions, and sparsity of data may be addressed using, e.g., dimensionality reduction techniques such as sample means of correlated observations, k-means clustering, k-nearest neighbors imputation, and principal component analysis. The data may be reduced to a matrix:

B=[β₀β₁] [Eq. 1]

where β₀ represents a vector of linear intercepts and β₁ a coefficient. Each section in a venue may be mapped many-to-one to a row (β₀, β₁) in B, and each event may be mapped uniquely to a base price \hat{p}ₑ determined by observing all transacted items from an event. These mappings are then used to create a prior price for any number of Bayesian algorithms using the formula:

(log p)ₚᵣᵢₒᵣ=β₀+β₁·\hat{p}ₑ. [Eq. 2]

This formula induces distinct prior prices for clusters of correlated tickets to an event, at which point transacted items can be treated as “new” information and a Bayesian process may be used to update the estimated prices for individual tickets according to secondary market ticket sales as they happen. Using this model, predicted ticket prices may be adjusted up or down relative to the base price (using, e.g., blended linear models) depending on a row within a section to arrive at a final predicted price for a ticket.

More generally, it will be appreciated that numerous statistical techniques are available for predicting a price based on historical transaction data. The inventors have observed, based on an analysis of secondary ticket sales for sporting events, that section-by-section ticket prices may vary significantly, but within a particular section prices are well correlated. At the same time, the row within a section may be a significant determinant of ticket value, and in particular the first row, the first two rows, and the first three rows are typically priced substantially above other rows in a section. Premium seating (e.g., indoor seating, club seating, etc.) may also command a substantial price differential relative to positionally adjacent, non-premium seating.

As such, a price prediction technique has been devised that determines as an initial matter a representative price for the current event, which may depend on a variety of factors such as the teams playing, the location of the event, a position of the current event within a season or within post-season playoffs, weather, weekday, time of day, relationship to holidays, and so forth. With this representative price, a corresponding representative price may be established for each section within a venue according to historical data (including listing data relating to, e.g., location and so forth). Each section may then be independently modeled to account for the discontinuities in pricing that occur in forward-most rows of the section. In one aspect, the same model and/or model coefficients (e.g., for statistical modeling) may be used for all sections, with a base price determined according to aggregate price behavior for a section. In another aspect, different pricing models and/or model coefficients may be used for each section, or for groups of sections that generally behave similarly (i.e., sections immediately left and right of a centerline for the venue, or sections opposite but symmetrically positioned within the venue). Thus the process may include grouping the secondary market data for the event into a plurality of groups of sections within a venue that have similar price variations relative to a representative price (such as the get-in price), or into a plurality of groups of sections that have similar seat-to-seat variations within the section. A representative price for each such group may be further adjusted according to the section row, the seat distance to the point of interest, and the seat viewing angle to the point of interest for the ticket.

While well known statistical modeling techniques provide a useful analytical framework for predicting prices, it will be appreciated that other techniques may be adapted to account for representative event pricing, section-specific pricing, and row-specific pricing as contemplated herein. Thus useful techniques for predictive modeling may include group methods of data handling, Naïve Bayes classifiers, k-nearest neighbor algorithms, majority classifiers, support vector machines, logistic regression, and uplift modeling. In one embodiment, predicting a price within a section of a venue includes predicting the price within the section using a posterior mean for the venue (or a cluster of sections within the venue) and the section. In another aspect, a hierarchical set of linear models may be provided for pricing, and one of the set may be selected based on, e.g., the event or the type of event (e.g., sports, music, theater, film, etc.). In another aspect, the model may be selected based on secondary market ticket data for the event, which may exhibit trends that suggest a specific pricing pattern for tickets within the event. The model may also or instead be selected based on primary market data for the event.

Price prediction may also or instead employ rule-based techniques and techniques such as neural networks, fuzzy logic, machine learning, and the like, as well as combinations of any of the foregoing.

In one aspect, predicted prices may be adjusted according to other available information, or according to other historical data. This adjustment may be incorporated into the pricing model(s) described above, or may be applied as a separate processing step after the other pricing model(s) have been applied in order to more precisely determine predicted prices, e.g., on a seat-by-seat basis, without requiring a seat-by-seat analysis of the secondary market transactional data. Thus for example, certain ticket group sizes may be more valuable than others, so a single ticket might be discounted relative to two tickets, which may be further discounted relative to four adjacent tickets, and so forth. Thus the predicted price for a ticket may be adjusted according to a number of tickets in a group that includes the ticket. In another aspect, prices may be adjusted within a particular section, such as by weighting ticket prices so that seats within a section closer to a location of interest within a venue, e.g., a centerline of a sports venue, have a greater predicted price than seats within the same section that are farther from the location of interest.

As shown in step 208, once a predicted price for a ticket is determined, the process 200 may include calculating a discount for the offering price of the ticket relative to the predicted price for the ticket. The discount may be an absolute discount (e.g., a simple difference between offered and predicted), or the discount may be a relative discount, which may be determined for example, as a percentage of the predicted price for the ticket, or relative to some other representative price such as a price for a row, section, or the current event. It will be noted that the steps of receiving an offering price, predicting a price, and calculating a discount may be repeated any number of times according to the number of tickets being offered for an event of group of events for which scoring is being calculated. In addition, these steps may be periodically repeated in order to update scoring as the secondary market for event tickets changes over time. Thus these steps may be repeated daily, hourly, by the minute, or in real time or near real time, or some combination of these, depending upon factors such as the availability of new transactional data, the rate of price change in the secondary market, changes in aggregate ticket availability, and so forth. In one aspect, the frequency of updates may be increased as an event approaches in order to reflect corresponding increases in secondary market transactions.

Other factors, such as a number of tickets in a group or a delivery method (e.g., e-ticketing) for the tickets, may also be factored into the predicted price, or applied to other steps such as ranking tickets. More generally, any factor that can be evaluated based on secondary market transactional data may be used as a factor in predicting a price for a ticket.

As shown in step 210, the process 200 may include ranking the ticket according to the discount relative to one or more additional discounts for one or more additional tickets to the current event including at least one ticket from a different section within the venue, thereby providing a rank for the ticket. Thus it will be noted that tickets in different sections are ranked together on the basis of the discount to the predicted price, thus permitting direct comparison of value among tickets with potentially highly disparate offering and/or predicted prices. Thus the offered tickets may be sorted into a ranked list according to discount. In one aspect, discount outliers may be removed from the group of tickets prior to ranking. In another aspect, the ranking may include a ranking of tickets for a plurality of related events that include the current event for a ticket. Related events may, for example, include all games for a sports team, a stretch of home games, a series of playoff games, a series of games against a specific team, all games against a specific team, a group of games within a specific time period, and so forth. Thus a user may view deal scores for a group of related events that facilitates direct comparison of tickets across the group of related events.

As shown in step 212, the process 200 may include scoring tickets, such as by assigning a score and a color code to each ticket offered for sale. Scoring may, for example, be normalized over a standard distribution onto a scale such as 0-5, 0-10, or 0-100, with individual scores allocated within the range of the scale according to rank within the ranked list, or according to the absolute or relative value of the discount. Prior to or after the normalization, additional standardization processes may be included within the scoring algorithm to account for known idiosyncrasies in seat quality or consumer preferences. Normalizing scores over a range of 0-100, for example, provides an intuitive representation of the quality of a particular deal, but other techniques may also suitably be employed. Scoring may instead use an unbounded value calculated according to any suitable formula. Thus in one aspect, where percentiles or the like are employed for scoring, a certain number of tickets may receive each score regardless of the relative discount. In another aspect, where the scores are allocated according to a relative discount or the like, tickets may be more or less densely clustered around a high, low, or mid-range score (or a number of scores) according to a corresponding distribution of discounts for all of the offered tickets.

With respect to color, any useful color scheme may be used. For example, tickets may be color coded into a small group of different, discrete colors such as red, yellow, and green, according to whether the ticket is a generally bad deal, average deal, or good deal. More generally, the tickets may be color coded using a color scheme selected from three or more colors, each representing a percentile range for the score. In another aspect, the color coding may use a continuous range of colors according to how good or bad a particular deal is on a particular ticket.

As shown in step 214, the method may include displaying the score and the color on a map of the venue at a location of the ticket within the venue. This may include, for example, providing an interactive venue map in a web page using any suitable web technology, and displaying available tickets in the map at suitable locations. In one aspect, the map may permit filtering so that only tickets meeting one or more user criteria are displayed, e.g., in order to permit quicker and easier visual inspection and sorting of ticket options. The one or more criteria for filtering may, for example, include number of tickets, price range, deal score, and any other suitable criteria. In one aspect, the criteria may include venue location, which may be specified in general terms (e.g., end zone, balcony, etc.), specific terms (e.g., by section, or by section/row), or through a graphical user interface, such as by lassoing or otherwise designating areas of interest on the venue map. In one aspect, the score and color for a ticket may be displayed within a visual marker such as a circle or square that includes a link to additional data about the ticket(s), which additional data may be accessed as a pop-up on a mouse over, as a hyperlink to the additional data, or using any other suitable user interface techniques.

As shown in step 216, the process 200 may optionally include an automated action based upon one or more ticket scores, which action(s) may be pre-defined by a user for automatic execution when tickets having certain characteristics become available. For example, the automated action may be taken when an offering price for a ticket meets a plurality of criteria including having a deal value metric (i.e., score) above a predetermined threshold. This may be a numerical threshold such as a score greater than a specific amount, or this may be a relative threshold such as a score in the top twenty five percent of deal scores. The other criteria may, for example, include an offering price for a ticket (such as a minimum or maximum price threshold), a seat, row, or section limitation (or other positional criterion), a minimum or exact number of tickets offered for sale in a group, and so forth.

In one aspect, the automated action may include sending an alert to a purchaser or potential purchaser that a ticket meeting the criteria is available for sale. This may include posting the ticket offer to an RSS feed, displaying the ticket offer on a mobile phone interface, sending an electronic mail or text message containing details, or communicating an alert to a user through any other suitable form of communication including combinations of any of the foregoing.

In another aspect, the automated action may include purchasing the ticket. For an automated ticket purchase, other information such as electronic transaction credentials and/or purchase limits may also be provided prior to initiation of the automated action. More generally, any automated action that can be defined in terms of triggering criteria and desired action may be suitably configured as an automated action based upon the deal score for a ticket.

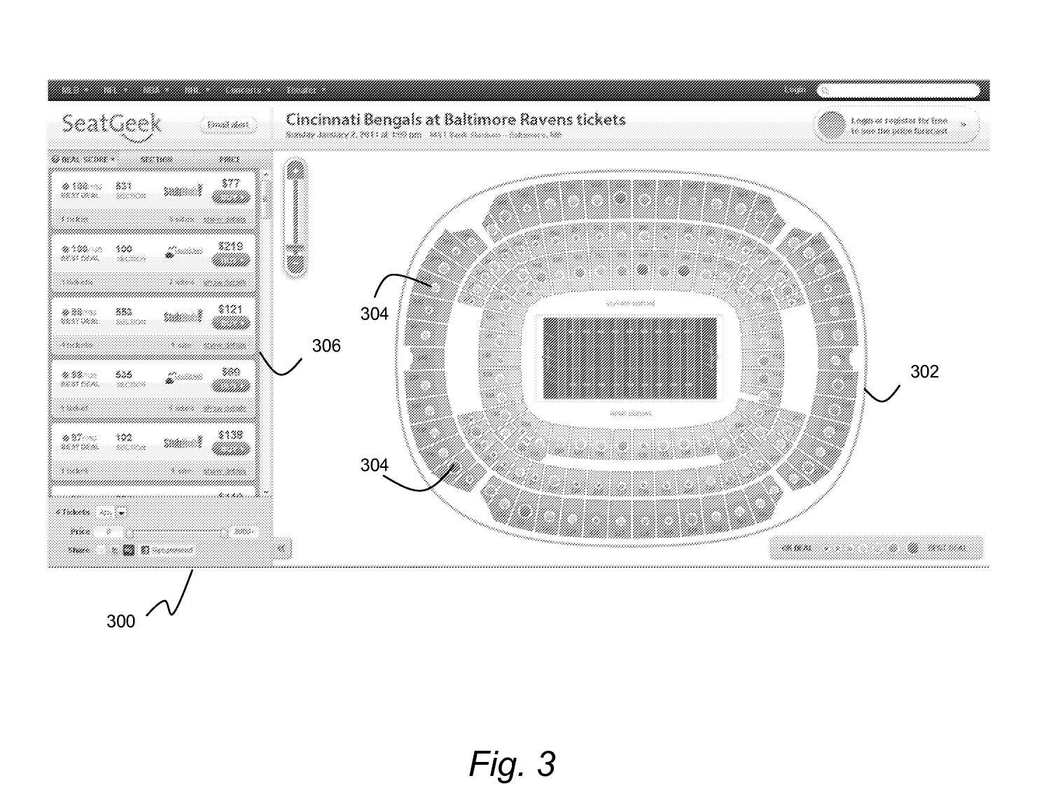

FIG. 3 shows an interactive graphical user interface displaying a deal value metric such as the ticket scores described above. The graphical user interface 300 may be rendered, for example, in a web browser of a client device that is connected through a data network such as the Internet to a web server. The interface may use HTML and/or any of a variety of web programming technologies including without limitation Java, Flash, Silverlight, and the like.

In general, the interface 300 may include a point and click interactive stadium map or venue map 302 that permits a user to navigate within the stadium e.g., by zooming, panning, or the like, for more detailed views of particular sections or areas within the stadium. Ticket availability may be graphically depicted within the interface using, e.g., visual markers 304 which may include color coded graphics to indicate availability and deal score (or ranges of deal score such as poor, okay, good, best, etc.). Fur a full stadium view, a generalized depiction of availability and/or deal score may be rendered for a section. For close ups of particular sections, each ticket or group of tickets may be depicted individually in substantially the appropriate seat location or row location within the venue map 302. Individual ticket offerings may also be displayed in text form, such as in a left-hand panel 306, with each offering accompanied by supplemental information such as the price, deal score, exact seat location, etc. These offerings may be interactively linked to the venue map 302 so that a user can have the particular seats or section highlighted on the stadium map by clicking on the textual ticket listings, or conversely so that the user can navigate to a specific detailed listing in the left-hand panel 306 by clicking on one of the visual markers 304. In addition, the left-hand panel 306 may provide color coding or other visual indicators of deal score. Thus in some embodiments, all tickets listings may be displayed in a table and ranked by deal score (or other criteria) in an area of the interface 300 such as the left-hand panel 306, and/or the deal score for each listing may be displayed next to the ticket. In other embodiments, the listings may be overlaid on an interactive map of the event venue, with a color-coded indicator or the like for each listing as function of the listing's deal score. Other interface features may be provided, such as a pop-up information box for each visual marker 304 that is available upon a mouse over of the visual marker 304.

User controls may be provided to filter available tickets by price, location, listing quantity, deal score or any other useful metrics, and/or to navigate (e.g., pan, zoom) within the venue map 302. Other conventional features such as a search bar, legend for color coding, and the like may be usefully included in the interface 300.

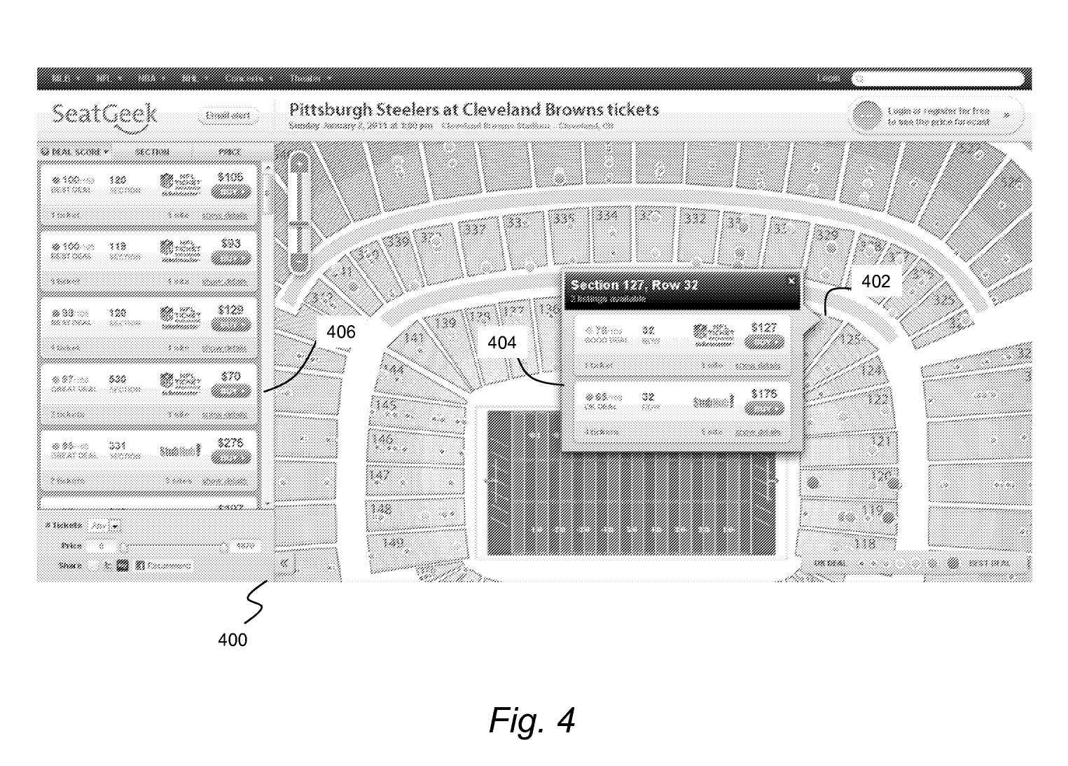

FIG. 4 shows a user interface with interactive access to ticket information. In particular, the interface 400 may include a call out 402 of detailed information for a particular ticket offering on a stadium map. In a zoomed mode, or as the density of information otherwise permits, each ticket or group of tickets offered for sale may be depicted as an interactive object 404. The object 404 may be for example a circle or other shape that is visually coded such as by using color to depict deal quality (e.g., shaded red for bad, green for good) and/or using size to depict number of available seats. Any other visual coding techniques may be usefully employed. The interface may respond to a mouse over or hover on a particular object 404 (or a click on the object 404 or the like) by displaying the call out 402 with further ticket details including, for example, other tickets that are for sale in a particular row or section. Other information such as the reseller, seat location, and so forth may also or instead be displayed, along with a user control such as a button that hyperlinks to a location where the displayed tickets can be purchased. The ticket listing within the call out 402, or within an information pane 406 or other area of the interface 400, may be further linked to a reseller website so that a user can navigate to the reseller site and initiate a purchase of the ticket(s).

It will be appreciated that many of the above systems, devices, methods, processes, and the like may be realized in hardware, software, or any combination of these suitable for the data processing, data communications, and other functions described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such clients, servers, and any number of remote web services or other servers, such as to provide secondary market ticket data or to process financial transactions. All such permutations and combinations are intended to fall within the scope of the present disclosure.

In other embodiments, disclosed herein are computer program products comprising computer-executable code or computer-usable code that, when executing on one or more computing devices, performs any and/or all of the steps described above. The code may be stored in a computer memory or other non-transitory computer readable medium, which may be a memory from which the program executes (such as internal or external random access memory associated with a processor), a storage device such as a disk drive, flash memory or any other optical, electromagnetic, magnetic, infrared or other device or combination of devices. In another aspect, any of the processes described above may be embodied in any suitable transmission or propagation medium carrying the computer-executable code described above and/or any inputs or outputs from same.

While particular embodiments of the present invention have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

1. A computer-implemented method of generating deal scores for tickets to an event that are on sale, comprising;
obtaining actual ticket transactional data from multiple data sources is a data network, where the actual ticket transactional data relates to actual ticket sales for one or more events of an event type at a venue;
generating inferred ticket transactional data, where the inferred ticket transactional data represents inferred sales of tickets for the one or more events of the event type at the venue, and wherein an inferred sale of a ticket is identified when a ticket that was once for sale is determined to no longer be for sale;
generating predicted prices of tickets for an event of the event type at the venue using the actual ticket transactional data and the inferred ticket transactional data, wherein the predicted prices of tickets are generated using a pricing model that treats different sections of seats within the venue differently, and that treats at least the first row of seats within a section differently from other rows of seats within the section;
obtaining ticket sale offer data for tickets that are for sale for a single event of the event type at the venue, wherein the ticket sale offer data includes, for each ticket, the offer price and the location of the seat within the venue that corresponds to the ticket;
calculating a discount for at least some of the tickets within the ticket sale offer data, where the discount for each ticket represents a difference between the offer price for the ticket and the predicted price for a ticket at that seat within the venue; and
generating a deal score for at least some of the tickets within the ticket sale offer data, where the deal score for each ticket is based on the calculated discount for that ticket.

2. The method of claim 1, wherein generating a deal score for at least some of the tickets within the ticket sale offer data comprises:
ranking at least some of the tickets in the ticket sale offer data relative to each other based on the calculated discounts for tickets; and
generating a deal score for at least some of the tickets within the ticket sale offer data based on the rankings of the tickets.

3. The method of claim 2, wherein the step of ranking at least some of the tickets in the ticket sale offer data comprises comparing the calculated discount for tickets to the calculated discounts of tickets that are located in both similar rows and similar sections of the venue.

4. The method of claim 1, further comprising:
obtaining additional ticket sale offer data for tickets that are for sale for additional events of the event type at the venue, wherein the additional ticket sale offer data includes, for each ticket, the offer price and the location of the seat within the venue that corresponds to the ticket; and
calculating a discount for at least some of the tickets within the additional ticket sale offer data, where the discount for each ticket represents a difference between the offer price for the ticket and the predicted price for a ticket at that seat within the venue;
wherein generating a deal score for at least some of the tickets within the ticket sale offer data for the single event comprises:
ranking at least some of the tickets in the ticket sale offer data for the single event relative to each other by comparing the calculated discounts for each ticket to the calculated discounts of tickets that are located in both similar rows and similar sections of the venue for both the single event and the additional events; and
generating a deal score for at least some of the tickets within the ticket sale offer data for the single event based on the rankings of the tickets.

5. The method of claim 1, wherein the steps of obtaining actual ticket transactional data and generating inferred ticket transactional data are repeated periodically, and wherein the step of generating predicted prices of tickets is repeated each time that new actual ticket transactional data is obtained and/or each time that new inferred ticket transactional data is generated.

6. The method of claim 1, wherein the calculated discount for tickets within the ticket sale offer data comprises a percentage difference between the offer price for the ticket and the predicted price for a ticket at that seat within the venue.

7. The method of claim 1, wherein the step of generating predicted prices of tickets for an event relies upon only actual ticket transactional data and inferred ticket transactional data for events that are similar to the event for which ticket sale offer data is obtained.

8. The method of claim 1, wherein the step of generating a deal score for at least some of the tickets within the ticket sale offer data comprises taking into account whether the ticket is being offered as part of a group of tickets for adjacent seats in the venue.

9. The method of claim 1, wherein the interred sale prices of tickets within the inferred ticket transactional data is the last known offer prices of the tickets.

10. A computer-implemented method of generating deal scores for tickets to an event that are on sale, comprising;
obtaining ticket transactional data for tickets that are for sale for one or more events of an event type at a venue, where the ticket transactional data comprises, for each ticket, the offer price and the location of the seat within the venue that corresponds to the ticket;
generating predicted prices of tickets for an event of the event type at the venue using the ticket transactional data, wherein the predicted prices of tickets are generated using a pricing model that treats different sections of seats within the venue differently, and that treats at least the first row of seats within a section differently from other rows of seats within the section;
obtaining ticket sale offer data for tickets that are for sale for a single event of the event type at the venue, wherein the ticket sale offer data includes, for each ticket, the offer price and the location of the seat within the venue that corresponds to the ticket;
calculating a discount for at least some of the tickets within the ticket sale offer data, where the discount for each ticket represents a difference between the offer price for the ticket and the predicted price for a ticket at that seat within the venue; and
generating a deal score for at least some of the tickets within the ticket sale offer data, where the deal score for each ticket is based on the calculated discount for that ticket.

11. The method of claim 10, wherein generating a deal score for at least some of the tickets within the ticket sale offer data comprises:
ranking at least some of the tickets in the ticket sale offer data relative to each other based on the calculated discounts for tickets; and
generating a deal score for at least some of the tickets within the ticket sale offer data based on the rankings of the tickets.

12. The method of claim 10, wherein the step of ranking at least some of the tickets in the ticket sale offer data comprises comparing the calculated discount for tickets to the calculated discounts of tickets that are located in both similar rows and similar sections of the venue.

13. The method of claim 10, further comprising:
obtaining additional ticket sale offer data for tickets that are for sale for additional events of the event type at the venue, wherein the additional ticket sale offer data includes, for each ticket, the offer price and the location of the seat within the venue that corresponds to the ticket; and
calculating a discount for at least some of the tickets within the additional ticket sale offer data, where the discount for each ticket represents a difference between the offer price for the ticket and the predicted price for a ticket at that seat within the venue;
wherein generating a deal score for at least some of the tickets within the ticket sale offer data for the single event comprises:
ranking at least some of the tickets in the ticket sale offer data for the single event relative to each other by comparing the calculated discounts for each ticket to the calculated discounts of tickets that are located in both similar rows and similar sections of the venue for both the single event and the additional events; and
generating a deal score for at least some of the tickets within the ticket sale offer data for the single event based on the rankings of the tickets.

14. The method of claim 10, wherein the step of obtaining ticket transactional data is repeated periodically, and wherein the step of generating predicted prices of tickets is repeated each time that new ticket transactional data is obtained.

15. The method of claim 10, wherein the calculated discount for tickets within the ticket sale offer data comprises a percentage difference between the offer price for the ticket and the predicted price for a ticket at that seat within the venue.

16. The method of claim 10, wherein the step of generating predicted prices of tickets for an event relies upon only ticket transactional data for events that are similar to the event for which ticket sale offer data is obtained.

17. The method of claim 10, wherein the step of generating a deal score for at least some of the tickets within the ticket sale offer data comprises taking into account whether the ticket is being offered as part of a group of tickets for adjacent seats in the venue.

18. The method of claim 10, further comprising generating inferred ticket transactional data, where the inferred ticket transactional data represents inferred sales of tickets for the one or more events of the event type at the venue, and wherein an inferred sale of a ticket is identified when a ticket that was once for sale is determined to no longer be for sale, and wherein the step of generating predicted prices of tickets for an event of the event type at the venue is performed using both the ticket transactional data and the inferred ticket transactional data.

19. A computer-based system for generating deal scores for tickets to an event that are on sale, comprising:
a data acquisition unit that obtains ticket data for tickets that are for sale for one or more events of an event type at a venue, where the obtained ticket data comprises, for each ticket, an offer price and a location of the seat within the venue that corresponds to the ticket, wherein the data acquisition unit also obtains ticket sale offer data for tickets that are for sale for a single event of the event type at the venue, where the ticket sale offer data includes, for each ticket, the offer price and the location of the seat within the venue that corresponds to the ticket; and
a scoring engine that:
generates predicted prices of tickets for an event of the event type at the venue using the obtained ticket data, wherein the predicted prices of tickets are generated using a pricing model that treats different sections of seats within the venue differently, and that treats at least the first row of seats within a section differently from other rows of seats within the section,
calculates a discount for at least some of the tickets within the ticket sale offer data, where the discount for each ticket represents a difference between the offer price for the ticket and the predicted price for a ticket at that seat within the venue; and
generates a deal score for at least some of the tickets within the ticket sale offer data, where the deal score for each ticket is based on the calculated discount for that ticket.

20. The system of claim 19, wherein the data acquisition unit also generates inferred ticket transactional data for inferred sales of tickets for the one or more events of the event type at the venue by inferring the sale of a ticket when a ticket that was once for sale is determined to no longer be for sale, and wherein the scoring engine generates predicted prices of tickets for an event of the event type at the venue using both the ticket data and the inferred ticket transactional data.

21. The system of claim 19, wherein the scoring engine generates a deal score for at least some of the tickets within the ticket sale offer data by:
ranking at least some of the tickets in the ticket sale offer data relative to each other based on the calculated discounts for tickets; and
generating a deal score for at least some of the tickets within the ticket sale offer data based on the rankings of the tickets.

22. The system of claim 21, wherein the scoring engine ranks at least some of the tickets in the ticket sale offer data by comparing the calculated discount for tickets to the calculated discounts of tickets that are located in both similar rows and similar sections of the venue.

23. The system of claim 19, wherein the data acquisition unit obtains additional ticket sale offer data for tickets that are for sale for additional events of the event type at the venue, wherein the additional ticket sale offer data includes, for each ticket, the offer price and the location of the seat within the venue that corresponds to the ticket, and wherein the scoring engine:
calculates a discount for at least some of the tickets within the additional ticket sale offer data, where the discount for each ticket represents a difference between the offer price for the ticket and the predicted price for a ticket at that seat within the venue;
generates a deal score for at least some of the tickets within the ticket sale offer data by:
ranking at least some of the tickets in the ticket sale offer data for the single event relative to each other by comparing the calculated discounts for each ticket to the calculated discounts of tickets that are located in both similar rows and similar sections of the venue for both the single event and the additional events; and
generating a deal score for at least some of the tickets within the ticket sale offer data for the single event based on the rankings of the tickets.

24. The system of claim 20, wherein the data acquisition unit periodically obtains ticket data, and wherein the scoring engine generates predicted prices of tickets each time that new ticket data is obtained by the data acquisition unit.

25. The system of claim 20, wherein the calculated discount for tickets within the ticket sale offer data comprises a percentage difference between the offer price for the ticket and the predicted price for a ticket at that seat within the venue.

26. The system of claim 20, wherein the data acquisition unit also obtains ticket sale data for tickets for one or more events of the event type at the venue, where the obtained ticket sale data comprises, for each ticket, a sale price and a location of the seat within the venue that corresponds to the ticket, and wherein the scoring engine generates predicted prices of tickets for an event based upon both the obtained ticket data and the obtained ticket sale data.

27. The system of claim 20, wherein the scoring engine takes into account whether a ticket is being offered as part of a group of tickets for adjacent seats in the venue when generating a deal score for the ticket.
